(19) United States
(12) Patent Application Publication
(10) Pub. No.: US 2013/0191191 A1
(43) Pub. Date: Jul. 25, 2013

(54) SYSTEM AND METHOD FOR MANAGING PARKING PASSES WHILE LIMITING THE PARKING PASS DEPENDING ON PARKING PASSES PREVIOUSLY PROVIDED TO A USER

(71) Applicants: Jerome Silvant, Montferrand Le Chateau (FR); David Perreard, Montferrand Le Chateau (FR)

(72) Inventors: Jerome Silvant, Montferrand Le Chateau (FR); David Perreard, Montferrand Le Chateau (FR)

(73) Assignee: PARKEON, Paris (FR)

(21) Appl. No.: 13/823,301

(22) PCT Filed: May 30, 2012
(86) PCT No.: PCT/EP2012/060185

§ 371 Date: Mar. 14, 2013

(30) Foreign Application Priority Data
May 31, 2011 (FR) 11 54743

(51) Int. Cl. G07B 1/00

(52) U.S. Cl. CPC G07B 1/00
USPC 705/13

(57) ABSTRACT

A method for managing parking passes via a system for managing parking passes, including at least one device for dispensing a parking pass, and a server for centralizing the parking passes, the centralization server being connected to the or each dispensing device via a data link, the method including the following steps: inputting (100) an identification code into the dispensing device (12) by a user; issuing (150) a parking pass to the user via the dispensing device; and recording (160) the parking pass in a file stored in a memory of the centralization server. The method further includes modifying a subsequent parking pass, for each identification code, depending on the previously output parking passes that were issued and recorded in the recording log file, each modification being associated with a parking zone and a time interval.

The present invention relates to a method for managing parking passes via a system for managing parking passes, including at least one device for dispensing a parking pass, and a server for centralising the parking passes, the centralisation server being connected to the or each dispensing device via a data link,

the said method comprising of the following steps:
a user inputting an identification code into the dispensing device,
the dispensing device issuing a parking pass to the user, and
recording the parking pass in a file stored in a memory of the centralisation server.

The invention also relates to a system for managing parking passes of the type comprising:
at least one device for dispensing a parking pass, the dispensing device comprising the means for inputting by a user of an identification code and the means for issuing the parking pass,
a server for centralising the parking passes, the centralisation server being connected to the or each dispensing device via a data link, the centralisation server including a memory for storing a log file for recording the parking passes issued for each identification code.

From the document EP 1 748 393 A1 a method and a system of management of the above type has already been known. The method comprises of the input of data for identifying the vehicle, such as the registration number of the vehicle, by the user by means of their mobile telephone. A parking pass is then issued to the user by the system for management of parking passes after payment of the appropriate fee amount corresponding to the parking pass, and the details and information related to the parking pass is recorded and stored in a memory of the server for centralising parking passes. The memory or database of the centralisation server includes predetermined constraints for limiting the parking period for certain parking zones where the parking time is limited.

In order to check the validity of a parking pass for a motor vehicle, a parking enforcement agent is provided with a portable terminal communicating with the centralisation server so as to query the database in the server with respect to the validity of the parking pass for a vehicle parked in a given parking space and which is being subjected to compliance checking. When querying the database, the parking enforcement agent identifies the vehicle by indicating its registration number.

However, the checking by the agent of compliance with certain parking regulations on the part of the user could prove to be particularly difficult in some situations, with the parking regulations being imposed by the operator in charge of the management system. This occurs, for example, when the agent has to check to ensure that the user has not exceeded the maximum permissible parking time in a given parking zone, by verifying in particular that the user has not successively purchased several parking passes for consecutive parking periods in the same parking zone, each parking pass individually representing a duration that is less than the maximum permissible parking time.

The aim of the invention is therefore to provide a method for managing parking passes that make it possible for a parking enforcement agent to more easily monitor and check for compliance with certain additional parking rules, in addition to checking the validity of the respective parking pass.

To this end, the invention relates to a method of the aforementioned type, characterised in that it further includes the modification of a subsequent parking pass, for each identification code, depending on the parking passes that were previously issued and recorded in the recording log file, each modification being associated with a parking zone and a time interval.

According to other embodiments, the method comprises one or more of the following characteristic features, taken individually or in accordance with all technically possible combinations:
the step of modifying the subsequent parking pass includes limiting the issuance of the subsequent pass;
the limitation on the issuance include the limitation of the parking time for a given parking zone;
the limitation on the issuance includes a prohibition on issuing a parking pass for a given parking zone and a time interval;
the limitation on the issuance includes a prohibition on issuing a parking pass for a given parking zone, time interval and category of subscribers, the subscribers having purchased a subscription with an operator in charge of the parking management system;
the step of modifying the subsequent parking pass includes computing a list of limitations on the issuance, the subsequent parking pass being issued only if it does not correspond to any of the limitations on the list of limitations on issuance;
the method further comprises of the following steps:
   the despatching, by the dispensing device to the centralisation server, of a request to obtain the list of limitations on issuance for the identification code input by the user, the list of limitations having been previously computed by the centralisation server, and
   the transmission, by the centralisation server to the dispensing device, of the list of limitations on issuance corresponding to the identification code input by the user;
the method further comprises of the following steps:
   the display by the dispensing device of only the parking pass or passes permissible taking into account the modification of the subsequent pass or passes, and
   the selection by the user of a parking pass from amongst those permissible;
the step of recording includes the storing of the details and information relating to the parking zone and the parking time period in the recording log file, and;
the method in addition includes the changing by the user of the parking pass issued, the said change being permissible only if the input of the identification code has been carried out using the data input means.

The invention also relates to a system of management of the aforementioned type, characterised in that it includes the means for modification of a subsequent parking pass, for each identification code, depending on the parking passes that were previously issued and recorded in the recording log file, each modification being associated with a parking zone and a time interval.

According to other embodiments, the system comprises of one or more of the following characteristic features, taken individually or in accordance with all technically possible combinations:
the means for modification include the means for limiting the issuance of the subsequent pass;
the system further comprises the means for computing a list of limitations on the issuance of the subsequent pass; and
the system further comprises the means for associating the identification code input with the other code or codes from among a plurality of identification codes when there are multiple identification codes associated with the same vehicle or the same subscriber, the computation means being capable of computing the list of limitations from the plurality of identification codes.

These characteristic features and advantages of the invention shall become apparent upon reading the following description, given solely by way of example and made with reference to the accompanying drawings, in which:

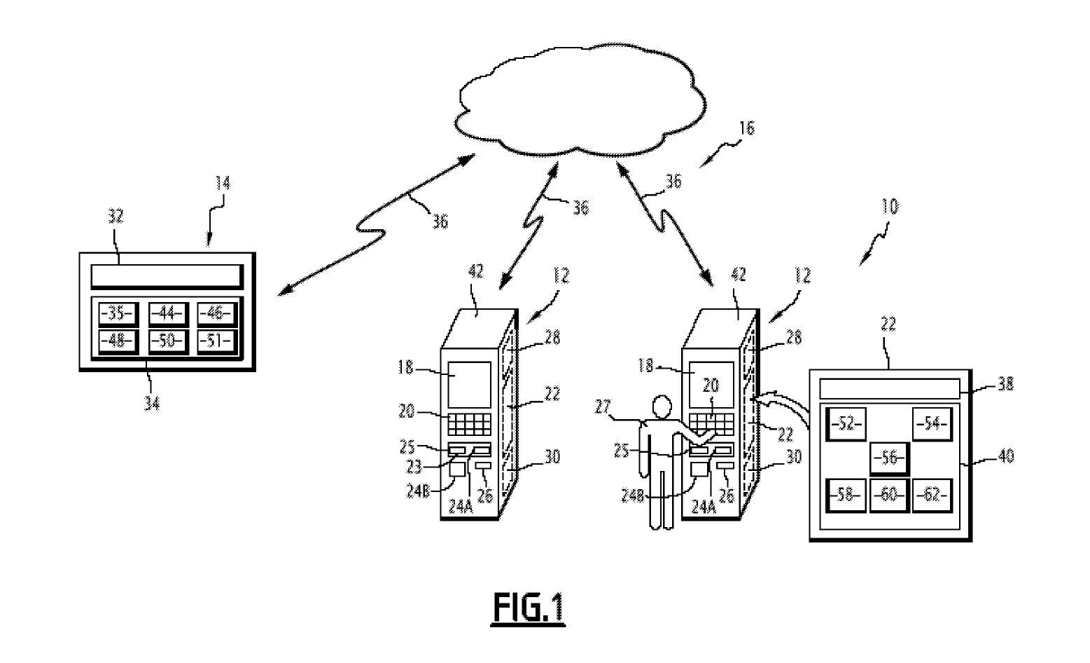

FIG. 1 is a schematic representation of a system for management of parking passes according to the invention, and

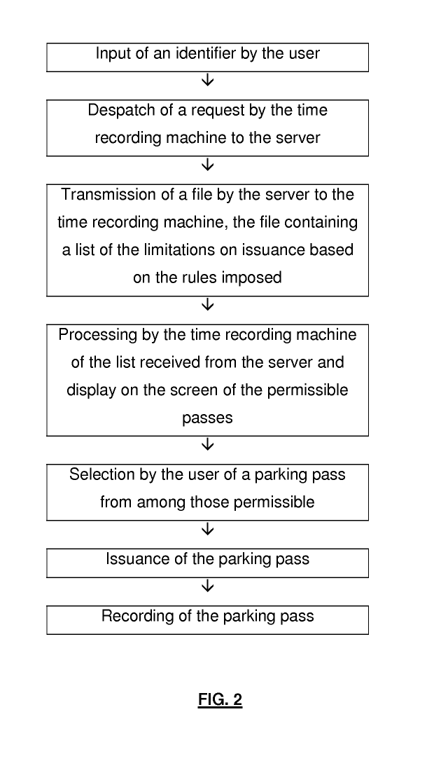

FIG. 2 is a flowchart of a method for managing parking passes by means of the system in FIG. 1.

In FIG. 1, a system 10 for managing parking passes comprises of two devices 12 for dispensing a parking pass and a server 14 for centralising the parking passes, the centralisation server 14 being connected to each dispensing device 12 by way of a communication network 16. The management system 10 is, for example, placed in an urban parking zone, each dispensing device 12 being placed along the roadways.

The dispensing device 12 comprises of a display screen 18, a keypad 20 for inputting alphanumeric characters, and an information processing unit 22.

In addition, the dispensing device 12 comprises a chip card reader 23, a contactless card reader 24A, an optical reader 24B, a payment device 25 and the means for printing 26.

The dispensing device 12 is, for example, a parking time recording machine. By way of a variant, the dispensing device 12 is a mobile phone or a computer connected to the centralisation server 14 by means of a network, for example via the Internet. When the dispensing device 12 is a mobile phone or a computer connected to the server 14 via a network, the payment is then made through a secure server for online payment.

The dispensing device 12 includes the means for inputting 27 by a user of an identification code and the means for issuing the parking pass, also known as parking voucher.

The management system 10 comprises of the means for modification of a subsequent parking pass for each identification code, depending on parking passes that were previously issued and recorded, each modification being associated with a parking zone and a time interval. The means for modification include, for example, the means for limiting the issuance of the subsequent pass.

The management system 10 comprises, for example, the means for computing a list of limitations on issuance of the subsequent pass.

In the example of the embodiment in FIG. 1, the dispensing device 12 comprises the means for modifying a subsequent parking pass.

The dispensing device 12 also includes the means 28 for communication in accordance with a communication protocol with the server 14 via the data link 16. The dispensing device 12 comprises the means 30 for electric power supply.

The centralisation server 14 includes a data processor 32 associated with a memory 34. The centralisation server 14 comprises the means for recording previously issued parking passes in a recording log file 35 stored in the memory 34.

In the example of the embodiment in FIG. 1, the centralisation server 14 includes the means for computing the list of limitations on issuance of the subsequent pass.

The communication network 16 is, for example, a wireless communication network comprising a radio link 36 between each dispensing device 12 and the centralisation server 14, as shown in FIG. 1. The wireless communication network is, for example, a GPRS network (from General Packet Radio Service) or a UMTS network (for Universal Mobile Telecommunication System).

By way of a variant, the communication network 16 is a wired network, comprising of a wired data link between each dispensing device 12 and the centralisation server 14.

The data input keypad 20 is, for example, a capacitive keypad independent of the display screen 18. By way of a variant, the data input keypad is a mechanical keypad. In another variant, the display screen is a touch screen, and the data input keypad is a touch panel keypad formed by key buttons displayed on the screen.

The information processing unit 22 includes, for example, a data processor 38 associated with a memory 40.

The chip card reader 23 and contactless card reader 24A are known per se. the optical reader 24B is known per se and is, for example, capable of read a barcode.

The payment device 25 comprises, for example, the chip card reader 23, the contactless card reader 24A and a coin-cash payment system, not shown.

The means for printing 26 are capable of printing the parking voucher and/or a receipt of payment made for obtaining a parking voucher.

The user 27 is, for example, a subscriber who has purchased a subscription with the operator in charge of the system for management of parking passes. The subscription offers preferential rates and a predetermined quota of parking passes for each preferential rate. Subscribers are, for example, divided into categories of subscribers with preferential rates and/or predetermined quotas associated with the various different categories. The different categories are, for example, the category of residents, the category of businesses, and the category of small suppliers—delivery services.

The means of communication 28 comprise a radio transmitter-receiver system compliant with the communication standard implemented by the communication network 16.

The power supply means 30 includes a rechargeable battery, not shown. The rechargeable battery is capable of being charged via a solar panel 42 arranged on the top of the dispensing device according to the example of the embodiment in FIG. 1 wherein the dispensing device 12 is a time recording machine. As a variant, the dispensing device 12 is connected to an electric power supply network via a wired electric power link.

The data input means comprise, for example, the data input keypad 16 when the identification code is the number of the license plate of the vehicle 27 of the user, a personal identifier of the user 27, a number inscribed on a previous parking ticket, a telephone number, a fine number, or a promotional code offered by a merchant.

The data input means include, for example, the chip card reader 23 when the identification code is an identifier from a user's bank/credit card 27.

The data input means include, for example, the contactless card reader 24A when the identification code is an identifier contained in a contactless magnetic card belonging to the user 27 or a radio identification badge or a RFID badge (for Radio Frequency IDentification).

The data input means comprise, for example, the optical reader 24B when the identification code is an identifier contained in a bar code.

Additionally, the data input means are secured means, for example when the contactless magnetic card or RFID badge include an anti card cloning device preventing fraudulent reproduction of the card or badge, or when a personal password is required in addition to the personal identifier of the user 27. The identification is also secured when the telephone number is transmitted as an identifier to the dispensing device 12 without being input by the user on the keypad 20. The telephone number is, for example, transmitted using the short range communication means provided, on the one hand, in the user's telephone, and on the other hand, in the dispensing device 12, and the secure data input means include the said short range communication means, such as communication means conforming to the IEEE 802.15 standard.

The memory 34 of the centralisation server is capable of storing a software 44 for recording previously issued parking passes in the recording log file 35. In the example of the embodiment in FIG. 1, the memory 34 is also capable of storing a software 46 for computing the list of limitations on the issuance of the subsequent pass, and a software 48 for transmitting to the dispensing device 12 a limitation file 50 containing the list of limitations for the identification code entered by the user 27. The file 50 is, for example, stored in the memory 34 of the server.

Additionally, the memory 34 is capable of storing a software 51 for associating the identification code entered with the other code or codes from among a plurality of identification codes when a plurality of identification codes is associated with the same vehicle or the same subscriber, the computation software 46 then being capable of computing the limitation list from the plurality of identification codes.

The recording software 44, the computation software 46, the data transmission software 48 and the software for identification code association 51 respectively form the recording means, the computing means, the data transmission means and the means for identification code association.

By way of a variant, the recording means, the computing means, the data transmission means and the ID code association means are developed in the form of programmable logic components, or in the form of dedicated integrated circuit/s.

Each radio link 36 is known per se, and is in compliance with the communication standard implemented by the communication network 16.

The memory 40 of the processing unit of the dispensing device 12 is capable of storing a software 52 for issuance of parking passes, a software 54 for modification of a subsequent parking pass for each identification code, depending on the parking passes that were previously issued and recorded in the recording log file 35, each modification being associated with a parking zone and a time interval.

The memory 40 is also capable of storing a software 56 for displaying the only parking pass or passes permissible for the corresponding identification code, taking into account the modification of the subsequent pass or passes.

In the example of the embodiment in FIG. 1, the memory 40 is also capable of storing a software 58 for despatching to the centralisation server 14, a request to obtain the recording log file 35. The request despatched by the despatching software 58 is preferably a request to obtain the limitation file 50 containing the list of limitations on issuance for the identification code input by the user 27, the list of limitations having been previously computed by using the computation software 46.

In the example of the embodiment in FIG. 1, the memory 40 is also capable of storing a software 60 for processing the recording log file 35 or the limitation file 50 received in response to the request despatched via the despatching software 58.

In addition, the memory 40 is capable of storing a software 62 for changing the parking pass issued, the change being controlled by a user after the latter has identified himself/herself, preferably in a secure manner.

The computation software 46 has predetermined functions, not shown, for computing the list of limitations, these functions corresponding to rules that are predetermined and imposed by the operator, such as a municipality, in charge of the management system 10.

The software for modification 54 includes additional software for imposing a limitation on issuance of the subsequent pass, such as a limitation on the parking time associated with a given parking zone, or even a prohibition on the issuance of a parking pass associated with a given parking zone and a given time interval. The limitation of the parking pass or prohibition on the issuance of a parking pass could result, for example, from a predetermined quota when the user 27 is a subscriber who has purchased a subscription with the operator in charge of the management system. The limitation of the parking pass or prohibition on the issuance of a parking pass are, for example, determined for a given class of subscribers.

The change management software 62 is in particular capable of reducing or increasing the duration of the parking pass issued, also called ‘current parking pass’. In other words, the change management software 62 is capable of suspending the current parking pass ahead of time or otherwise extending the said current pass without having to obtain a new parking pass.

The pass issuing software 52, the software for modification 54, the display software 56, the despatching software 58, the processing software 60 and the change management software 62 respectively form the issuing means, the modification means, the display means, the despatching means, the processing means and the change management means.

By way of a variant, the issuing means, the modification means, the display means, the despatching means, the processing means and the change management means are developed in the form of programmable logic components, or also in the form of dedicated integrated circuit/s.

The operation of the management system 10 according to the invention will now be explained by way of using the flowchart in FIG. 2.

During the initial step 100, the user 27 inputs, into the dispensing device 12, their identification code using the data input means 20, 23, 24A, 24B.

The dispensing device 12 then despatches, to the centralisation server 14 and with the help of the despatching software 58, a request for obtaining the limitation file 50 as shown in the example in FIG. 2 (step 110).

By way of a variant, the dispensing device 12 despatches to the centralisation server 14, a request for obtaining the recording log file 35.

In response to the request received, the centralisation server 14 transmits, during step 120, to the dispensing device 12 and by means of the data transmission software 48, limitation file 50 containing the list of limitations for the identification code input by the user 27.

By way of a variant, the centralisation server 14 transmits, in response to the request received, to dispensing device 12 and by means of the data transmission software 48, the recording log file 35.

Additionally, when multiple identification codes correspond to the same vehicle or the same subscriber, the centralisation server 14 associates the identification code input by the user and received from the dispensing device 12, with the other identification code or codes corresponding to the same vehicle or the same subscriber, in order to determine the limitation file 50 or the recording log file 35 for all the identification codes corresponding to the same vehicle or the same subscriber.

The dispensing device 12 then processes, with the help of the processing software 60, the limitation file 50 received, containing in particular the list of limitations for the identification code of the user 27 (step 130). It then displays on the screen 18 only the parking pass or passes permissible for the corresponding identification code, taking into account the limitation with respect to the subsequent pass or passes, previously determined by the centralisation server 14. The person skilled in the art will understand that the subsequent passes determined during the previous step relating to limitation correspond to the permissible passes displayed during step 130. In other words, the dispensing device displays only the permissible pass or passes, and does not display the passes that cannot be issued on account of the limitation resulting from the rules imposed by the operator.

By way of a variant, the dispensing device 12 processes, with the help of the processing software 60, the recording log file 35 received, and displays on the screen 18 only the parking pass or passes permissible for the corresponding identification code, taking into account the modification of the subsequent pass or passes, the modification having been determined previously with the help of the modification software 54 of the dispensing device. The person skilled in the art will also understand that the subsequent passes, determined during the previous modification step, correspond to the permissible passes displayed during this step.

During step 140, the user 27 then selects, with the help of the keypad 20, the desired parking pass from among the pass or passes that are permissible and displayed. She/he makes the payment corresponding to the selected parking pass by means of the payment device 25 if necessary, the parking pass being free in certain instances.

The parking pass is finally issued in step 150 by the pass issuing software 52.

Following the issuance of the parking pass, the details and information regarding the parking pass, in particular those relating to the parking zone and the parking time are transmitted to the centralisation server 14 by the dispensing device 12, so as to be recorded in the recording log file 35 during step 160.

Additionally, when the user is identified, preferably in a secure manner, the latter has the ability to reduce or increase the duration of the parking pass issued to her/him, also called current parking pass, with the help of the change management software 62. In other words, if the needs of the user 27 have changed, the latter could suspend the current parking pass ahead of time or on the contrary, extend said current pass without having to obtain a new parking pass.

The details and information regarding the parking pass thus changed with the help of the change management software 62 are transmitted to the centralisation server 14 by the dispensing device 12, so as to be recorded in the recording log file 35. Such a change in the current parking pass will therefore have an effect on the modification of the subsequent parking pass.

The management system 10 according to the invention thus makes it possible to modify the subsequent parking pass for each identification code, depending on the parking passes previously issued and recorded in the recording log file 35, each modification being associated with a parking zone and a time interval. This modification of the subsequent parking pass makes it possible to take into account the parking rules imposed by the operator in charge of the management system, while ensuring that complexity is not added to the control and checking performed by the parking enforcement agent. Indeed, the subsequent parking pass, before being issued, is modified in a manner such that it complies with the rules imposed, and the agent then is thus only required to verify compliance with these rules by the user 27.

The parking regulations imposed are associated with a given vehicle or a given subscriber, and when there are multiple identification codes corresponding to the said vehicle or to said subscriber, the identification code association software 51 associates all of the identification codes corresponding to the same vehicle or to the same subscriber from the single identification code that has been input. This then makes possible the determination in a comprehensive manner of the limitation file 50 or the recording log file 35 for the vehicle or the subscriber, despite the existence of multiple identification codes corresponding to the said vehicle or to said subscriber. In other words, the subsequent parking pass, before being issued, is modified in a manner such that it complies with the rules imposed, even though several identification codes correspond to the vehicle or to the subscriber and whereas only one single code has been input by the user 27.

The outcome of this modification may include, for example, a limitation on the parking time associated with a given parking zone, or even a prohibition on the issuance of a parking pass associated with a given parking zone and a given time interval.

The limitation on the parking pass or the prohibition on the issuance of a parking pass are, for example, associated with a given category of subscribers.

The modification corresponds, for example, to a predetermined quota when the user 27 is a subscriber who as purchased a subscription with the operator in charge of the management system.

By way of a variant, when the subsequent parking pass is issued only if it does not correspond to any of the limitations on the list of limitations on pass issuance, the rules imposed then also necessarily have to be complied with, since the limitation was previously computed in a manner so as to comply with these imposed rules.

This limitation is, for example, a limitation on the issuance of the subsequent pass, such as a limitation on the parking time associated with a given parking zone, or even a prohibition on the issuance of a parking pass associated with a given parking zone and a given time interval. The limitation on the parking pass or the prohibition on the issuance of a parking pass are the result, for example, of a predetermined quota when the user is a subscriber 27.

The transmission of the limitation file 50 by the server 14 to the dispensing device 12 facilitates the determination by the dispensing device 12 of the subsequent passes permissible for the identification code input, since the computations were previously performed by the computation software 46 of the server. This also helps to improve the operating range of the dispensing device 12 when the latter is supplied with electric power by the rechargeable battery.

The person skilled in the art will understand that the system and method according to the invention include, according to another embodiment, the transmission of an authorisation file by the server 14 to the dispensing device 12, in place of the limitation file 50, the authorisation file containing a list of authorisations for issuance, the subsequent pass parking being issued only if it corresponds to an authorised item on the list of authorisations for issuance.

In this way it is thus conceivable that the system and method according to the invention enables a parking enforcement agent to easily check and verify compliance with certain additional parking rules, in addition to checking the validity of the respective parking pass.

1. A method for managing parking passes via a system (10) for managing parking passes including at least one device (12) for dispensing a parking pass and a server (14) for centralising the parking passes, the centralisation server (14) being connected to the or each dispensing device (12) via a data link (16),
the method comprising the following steps:
the inputting (100) by a user (27) of an identification code into the dispensing device (12),
the issuing (150) to the user (27) of a parking pass by the dispensing device (12),
the recording (160) of the parking pass issued in a file (35) stored in a memory (34) of the centralisation server (14),
characterised in that it further includes the modification of a subsequent parking pass, for each identification code, depending on the parking passes that were previously issued and recorded in the recording log file (35), each modification being associated with a parking zone and a time interval.

2. A method according to claim 1, wherein the step of modifying the subsequent parking pass includes limiting the issuance of the subsequent pass.

3. A method according to claim 2, wherein the limitation on the issuance include the limitation of the parking time for a given parking zone.

4. A method according to claim 2, wherein the limitation on the issuance includes a prohibition on issuing a parking pass for a given parking zone and a time interval.

5. A method according to claim 2, wherein the limitation on the issuance includes a prohibition on issuing a parking pass for a given parking zone, a time interval and a category of subscribers, the subscribers having purchased a subscription with an operator in charge of the parking management system (10).

6. A method according to claim 2, wherein the step of modifying the subsequent parking pass includes computing a list of limitations on issuance, the subsequent parking pass being issued only if it does not correspond to any of the limitations on the list of limitations on issuance.

7. A method according to claim 6, further comprising the following steps:
the despatching (110), by the dispensing device (12) to the centralisation server (14), of a request to obtain the list of limitations on issuance for the identification code input by the user (27), the list of limitations having been previously computed by the centralisation server (14), and
the transmission (120), by the centralisation server to the dispensing device (12), of the list of limitations on issuance corresponding to the identification code input by the user (27).

8. A method according to claim 1, further comprising the following steps of:
the display (130) by the dispensing device (12) of only the parking pass or passes permissible taking into account the modification of the subsequent pass or passes, and
the selection (140) by the user (27) of a parking pass from amongst those permissible.

9. A method according to claim 1, wherein the step of recording includes the storing of the details and information relating to the parking zone and the parking time period in the recording log file.

10. A method according to claim 1, further including the changing by the user (27) of the parking pass issued, the said change being permissible only if the input (100) of the identification code has been carried out using the data input means (20, 23, 24A, 24B).

11. The system (10) for managing the parking passes, of the type comprising:
at least one device (12) for dispensing a parking pass, the dispensing device (12) comprising the means for inputting (20, 23, 24A, 24B) by a user (27) of an identification code and the means for issuance of the parking pass,
a server (14) for centralising the parking passes, the centralisation server being connected to the or each dispensing device (12) via a data link (16), the centralisation server (14) including a memory (34) for storing a log file (35) for recording the parking passes issued for each identification code,
characterised in that it includes the means for the modification of a subsequent parking pass, for each identification code, depending on the parking passes that were previously issued and recorded in the recording log file (35), each modification being associated with a parking zone and a time interval.

12. A system (10) according to claim 11, wherein the means for modification include the means for limiting the issuance of the subsequent pass.

13. A system (10) according to claim 11, further comprising the means (46) for computing a list of limitations on the issuance of subsequent pass.

14. A system (10) according to claim 13, further comprising the means (51) for associating the identification code input with the other code or codes from among a plurality of identification codes when there are multiple identification codes associated with the same vehicle or the same subscriber, the computation means (46) being capable of computing the list of limitations from the plurality of identification codes.

15. A method according to claim 3, wherein the limitation on the issuance includes a prohibition on issuing a parking pass for a given parking zone and a time interval.

16. A method according to claim 3, wherein the limitation on the issuance includes a prohibition on issuing a parking pass for a given parking zone, a time interval and a category of subscribers, the subscribers having purchased a subscription with an operator in charge of the parking management system (10).

17. A method according to claim 4, wherein the limitation on the issuance includes a prohibition on issuing a parking pass for a given parking zone, a time interval and a category of subscribers, the subscribers having purchased a subscription with an operator in charge of the parking management system (10).

18. A method according to claim 3, wherein the step of modifying the subsequent parking pass includes computing a list of limitations on issuance, the subsequent parking pass being issued only if it does not correspond to any of the limitations on the list of limitations on issuance.

19. A method according to claim 4, wherein the step of modifying the subsequent parking pass includes computing a list of limitations on issuance, the subsequent parking pass being issued only if it does not correspond to any of the limitations on the list of limitations on issuance.

20. A system (10) according to claim 12, further comprising the means (46) for computing a list of limitations on the issuance of subsequent pass.
